(19) United States
(12) Patent Application Publication
(10) Pub. No.: US 2015/0324166 A1
(43) Pub. Date: Nov. 12, 2015

(54) Systems and Methods for Webpage Sound Control

(71) Applicant: Tencent Technology (Shenzhen) Company Limited, Shenzhen (CN)

(72) Inventor: Baike Lin, Shenzhen (CN)

(21) Appl. No.: 14/798,539

(22) Filed: Jul. 14, 2015

Related U.S. Application Data
(63) Continuation of application No. PCT/CN2014/080859, filed on Jun. 26, 2014.

(30) Foreign Application Priority Data
Jun. 28, 2013 (CN) 201310270405.2

(51) Int. Cl. G06F 3/16; H04L 29/08; G06F 17/30; H04L 29/06

(52) U.S. Cl. CPC G06F 3/165; H04L 67/42; H04L 67/02; G06F 17/3089

(57) ABSTRACT

Systems, devices and methods are provided for webpage sound control. For example, one or more audio webpages are obtained from webpages opened in a browser, the audio webpages being loaded with media information; an operation widget is configured based on at least information associated with the audio webpages, the operation widget being configured to gather operations associated with the audio webpages; one or more operations triggered for the operation widget are received; and one or more operation instructions associated with the audio webpages are executed based on at least information associated with the received operations. The operation instructions are configured to control the audio webpages.

### CROSS-REFERENCES TO RELATED APPLICATIONS

The application claims priority to Chinese Patent Application No. 201310270405.2, filed Jun. 28, 2013, incorporated by reference herein for all purposes.

### BACKGROUND OF THE INVENTION

Certain embodiments of the present invention are directed to communication technology. More particularly, some embodiments of the invention provide systems and methods for media playing. Merely by way of example, some embodiments of the invention have been applied to webpages. But it would be recognized that the invention has a much broader range of applicability.

Users often open webpages in a browser and access Internet resources. With growing demand for browsing different webpages, browsers are adapted to open more and more webpages.

In a browser that supports multiple webpages, a large number of webpages are often opened for user access. When an audio webpage is opened in a browser, sounds may be played in this scenario. For example, the audio webpage may play music, or play sound effects of a video.

It is often difficult, however, for a user to determine, among multiple webpages that are opened, which one is the audio webpage, and thus it is usually hard to achieve precise control of the audio web webpage.

Hence it is highly desirable to improve the techniques for webpage sound control.

### BRIEF SUMMARY OF THE INVENTION

According to one embodiment, a method is provided for webpage sound control. For example, one or more audio webpages are obtained from webpages opened in a browser, the audio webpages being loaded with media information; an operation widget is configured based on at least information associated with the audio webpages, the operation widget being configured to gather operations associated with the audio webpages; one or more operations triggered for the operation widget are received; and one or more operation instructions associated with the audio webpages are executed based on at least information associated with the received operations. The operation instructions are configured to control the audio webpages.

According to another embodiment, a device for webpage sound control includes: a webpage capturing module configured to capture one or more audio webpages from webpages opened in a browser, the audio webpages being loaded with media information, a configuration module configured to configure an operation widget based on at least information associated with the audio webpages, the operation widget being configured to gather operations associated with the audio webpages, and an execution module configured to receive one or more operations triggered for the operation widget and execute one or more operation instructions associated with the audio webpages based on at least information associated with the received operations. The operation instructions are configured to control the audio webpages.

According to yet another embodiment, a non-transitory computer readable storage medium includes programming instructions for webpage sound control. The programming instructions are configured to cause one or more data processors to execute certain operations. For example, one or more audio webpages are obtained from webpages opened in a browser, the audio webpages being loaded with media information; an operation widget is configured based on at least information associated with the audio webpages, the operation widget being configured to gather operations associated with the audio webpages; one or more operations triggered for the operation widget are received; and one or more operation instructions associated with the audio webpages are executed based on at least information associated with the received operations. The operation instructions are configured to control the audio webpages.

For example, the devices and methods disclosed herein are configured to provide an operation widget for a user to locate an audio webpage through the operation widget without manually searching in all webpages opened in a browser one at a time so as to achieve precise control of audio webpages using the operation widget.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for webpage sound control according to one embodiment of the present invention.

FIG. 2 is a simplified diagram showing a process for configuring an operation widget as part of the method as shown in FIG. 1 according to one embodiment of the present invention.

FIG. 3 is a simplified diagram showing a process for receiving one or more operations and executing one or more operation instructions as part of the method as shown in FIG. 1 according to one embodiment of the present invention.

FIG. 4-FIG. 8 are simplified diagrams showing operations for performing the method as shown in FIG. 1 according to some embodiments of the present invention.

FIG. 9 is a simplified diagram showing a device for webpage sound control according to one embodiment of the present invention.

FIG. 10 is a simplified diagram showing a configuration module as part of the device as shown in FIG. 9 according to one embodiment of the present invention.

FIG. 11 is a simplified diagram showing an execution module as part of the device as shown in FIG. 9 according to one embodiment of the present invention.

### DETAILED DESCRIPTION OF THE INVENTION

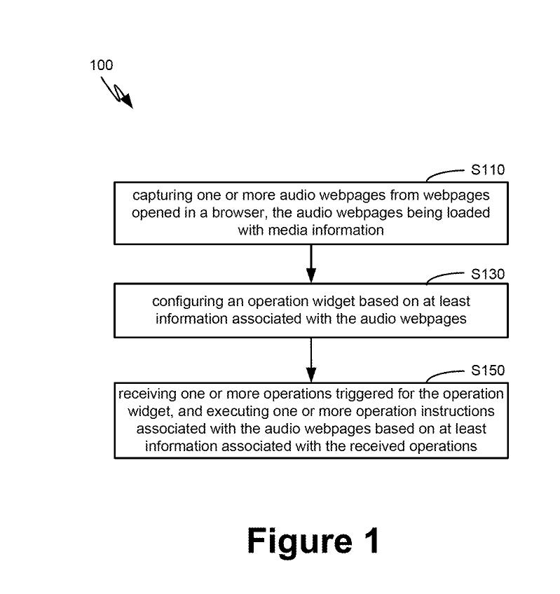

FIG. 1 is a simplified diagram showing a method for webpage sound control according to one embodiment of the present invention. The diagram is merely an example, which should not unduly limit the scope of the claims. One of ordinary skill in the art would recognize many variations, alternatives, and modifications. The method 100 includes at least processes S110, S130, and S150.

According to one embodiment, the process S110 includes capturing one or more audio webpages from webpages opened in a browser, the audio webpages being loaded with media information. For example, if the webpages opened in the browser contain one or more audio webpages, the one or more audio webpages among the webpages opened in the browser are captured in order to obtain the audio webpages. As an example, audio webpages are webpages loaded with audio or video media information, such as webpages that play video or other streaming audio media, webpages containing streaming media advertising, etc.

According to another embodiment, multiple webpages opened in a browser may include audio webpages, and other webpages loaded with text information and/or image information. For example, the webpages that are opened in the browser appear as tabs in a browser interface, or in the format of a webpage window. In another example, on a personal computer, multiple webpages are opened as tabs in a browser that supports tabs. In yet another example, on a handheld device platform, multiple webpages are opened as webpage windows.

According to yet another embodiment, the process S130 includes configuring an operation widget based on at least information associated with the audio webpages. For example, the operation widget is configured to gather operations associated with all the audio webpages so that all the operations triggered through the audio webpages by a user can be performed through the operation widget. After the audio webpages from the opened webpages are captured and obtained, the operation widget is configured based on the audio webpages so that the operations associated with the audio webpages are gather through the operation widget, in some embodiments. For example, a corresponding operation interface is configured in the operation widget based on the audio webpages. As an example, the operation interface includes a button for controlling playing of the audio webpages, a preview interface corresponding to the audio webpages, and a close button corresponding to the audio webpages.

In one embodiment, while the audio webpages are captured, the operation widget, after being configured, floats in the browser interface, and disappears in the browser interface once all the audio webpages among all webpages are closed, so that the disturbance caused to the browser interface can be avoided. For example, a minimize button and an expanding button are configured in the operation widget. As an example, the operation widget can be minimized once a user clicks on the minimize button, so that the operation widget disappears in the browser. In another example, the expanding button is configured in the browser interface. In yet another example, the operation widget can be minimized if the user does not need control over the audio webpages. In yet another example, if the operation widget is needed, the operation widget can be obtained in response to the user's clicking on the expanding button.

In another embodiment, the process S150 includes: receiving one or more operations triggered for the operation widget, and executing one or more operation instructions associated with the audio webpages based on at least information associated with the received operations. For example, the operation instructions are configured to control at least one audio webpage, and include playing, previewing, and closing the audio webpages. As an example, the operations triggered from the operation widget are detected, and the control of playing, previewing and closing the audio webpages is achieved based on the detected operations. The audio webpages opened in the browser are gathered and clarified through the operation widget, so that a user may locate the audio webpages and control the audio webpages quickly and easily through the operation widget which is integrated and easily operated, according to certain embodiments.

In yet another embodiment, the operation widget is configured to execute a same operation for all audio webpages. For example, the same operation can be executed through all the audio webpages opened in the browser through the operation widget. As an example, the operation of stopping or pausing playing can be executed to all the audio webpages so that all the audio webpages are controlled quickly and easily, so as to avoid the disturbance caused to the user.

According to one embodiment, the process S150 includes: detecting a first operation that triggers the operation widget to stop or pause media playing on the one or more audio webpages and stopping or pausing media playing on the one or more audio webpage based on at least information associated with the first operation. For example, if the operation widget configured for the audio webpages detects the operation that triggers stopping or pausing the media playing of at least one audio webpage, then media playing of the audio webpages is stopped or paused. In another example, if the operation widget that is configured and obtained based on the audio webpages configures a button to control playing of at least one audio webpage, e.g., a button for stopping and/or pausing content, then media playing can be stopped or paused after the operation triggered from the button is detected. In yet another example, when the operation for the button is triggered again, media playing of the audio webpages resumes or continues.

In some embodiments, media playing of one or more audio webpages is controlled through the operation widget so as to avoid inconvenience caused to a user when the user cannot locate which webpage performs media playing to make sounds. For example, the user opens multiple webpages using a browser, but the user has not finished browsing the opened webpages when the browser is closed. As an example, the opened webpages are not closed and thus the unclosed webpages are recovered automatically when the browser is opened again. The recovered audio webpages may make sounds and cause inconvenience to the user. The operation widget and the operation triggered from the operation widget can improve webpage sounds control, according to certain embodiments.

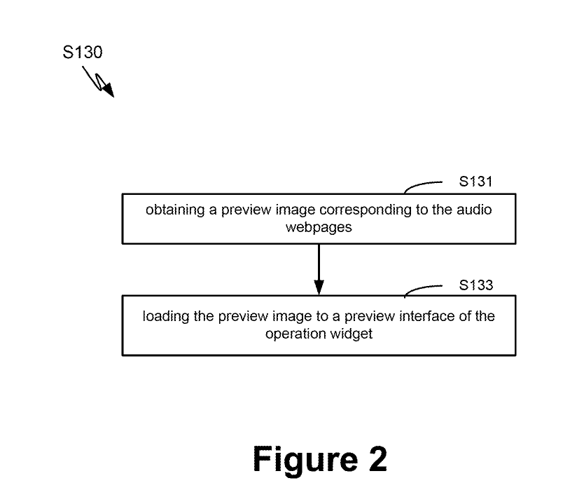

FIG. 2 is a simplified diagram showing a process for configuring an operation widget as part of the method as shown in FIG. 1 according to one embodiment of the present invention. The diagram is merely an example, which should not unduly limit the scope of the claims. One of ordinary skill in the art would recognize many variations, alternatives, and modifications.

According to one embodiment, the process S130 includes: a process S131 for obtaining a preview image corresponding to the audio webpages, and a process S133 for loading the preview image to a preview interface of the operation widget. For example, a preview is obtained corresponding to each audio webpage that is captured. In another example, the preview interface of the operation widget is loaded with the obtained preview one at a time, so that the user is able to preview the audio webpages through the operation widget.

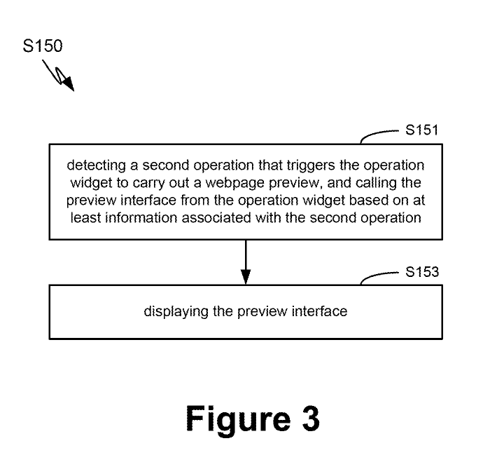

FIG. 3 is a simplified diagram showing a process for receiving one or more operations triggered for the operation widget and executing one or more operation instructions associated with the audio webpages as part of the method as shown in FIG. 1 according to one embodiment of the present invention. The diagram is merely an example, which should not unduly limit the scope of the claims. One of ordinary skill in the art would recognize many variations, alternatives, and modifications.

According to one embodiment, the process S150 includes: a process 151 for detecting a second operation that triggers the operation widget to carry out a webpage preview and calling the preview interface from the operation widget based on at least information associated with the second operation. For example, an operation for previewing audio webpages triggered through the operation widget calls one or more preview pages. As an example, the preview pages are loaded with preview images corresponding to the audio webpages. In another example, a preview button is configured in the operation widget, and the operation triggered for the preview button calls the preview interface corresponding to the audio webpages from the operation widget.

According to another embodiment, the process S153 includes displaying the preview interface. For example, the called preview interface is displayed through the operation that triggers the operation widget to preview the webpages, so that the user is able to preview every opened audio webpage using the preview interface. in another example, preview of all the captured audio webpages among the opened webpages can be achieved in the preview interface. Which opened webpages are audio webpages are determined through the preview interface according to certain embodiments. For example, the called preview interface is displayed above the operation widget, so that the preview corresponding to the audio webpages loaded one at a time is displayed in parallel in the preview interface.

According to yet another embodiment, the process S150 includes: obtaining a selection operation triggered in the preview interface, and redirecting from a currently displayed webpage to the one or more audio webpage corresponding to the preview interface based on at least information associated with the selection operation. For example, the audio webpages are previewed through the preview images loaded in the preview interface. In another example, a selection operation triggered for a preview image in the preview interface is obtained, and the selected preview image is acquired based on the selection operation. A redirection from a current webpage in the browser to an audio webpage corresponding to the preview image is performed so as to realize the switching between the current webpage and the audio webpage without requiring the user to search for the audio webpage, which results in improvement of the operation efficiency, according to certain embodiments.

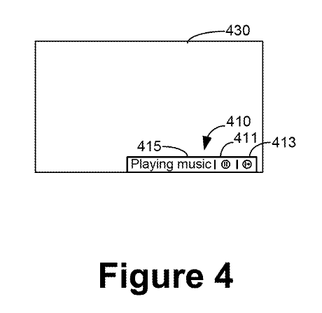

FIG. 4-FIG. 8 are simplified diagrams showing operations for performing the method as shown in FIG. 1 according to some embodiments of the present invention. The diagrams are merely examples, which should not unduly limit the scope of the claims. One of ordinary skill in the art would recognize many variations, alternatives, and modifications.

As shown in FIG. 4, multiple webpages are opened in a browser and correspond to multiple tabs, where the opened webpages include one or more audio webpages, according to one embodiment. For example, an operation widget 410 is configured based on the audio webpages, and located at a bottom right corner of the preview interface 430. In another example, the operation widget includes a pause button 411 for pausing media playing of the audio webpages, a minimize button 413, and a text element 415. The content of the text element corresponds to the status of media playing of the audio webpages, in some embodiments. For example, the content includes “playing music” or “playing paused.” In another example, the pause button 411 is used to pause media playing on the audio webpages, and the operation widget 410 can be minimized using the minimize button 413.

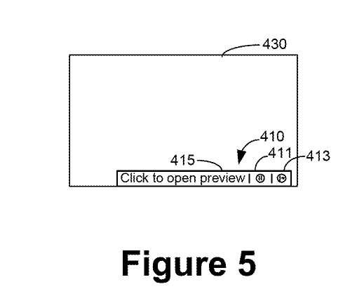

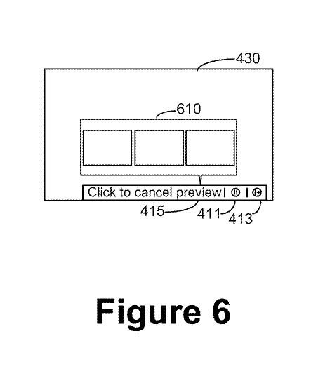

As shown in FIG. 5, when a user moves a mouse over the text element 415, the content of the text element 415 changes to “click to open preview,” according to another embodiment. For example, the user clicks the text element 415 to call a preview interface of the audio webpage. As shown in FIG. 6, the preview interface 610 loaded with the preview images of the audio webpages is displayed above the operation widget 410 for easy preview, according to yet another embodiment.

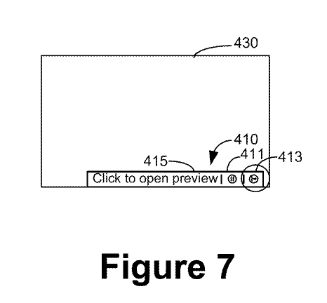

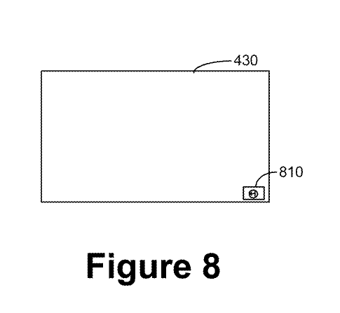

As shown in FIG. 7, when the operation widget 410 is not needed, the user can click on the minimize button 413 in the browser interface 430 to minimize the operation widget 410, according to some embodiments. As shown in FIG. 8, the expand button 810 is configured in the browser interface 430, according to certain embodiments. For example, the minimized operation widget 410 can be expanded when the user clicks on the expand button 810, so that the user can operate on the audio webpages.

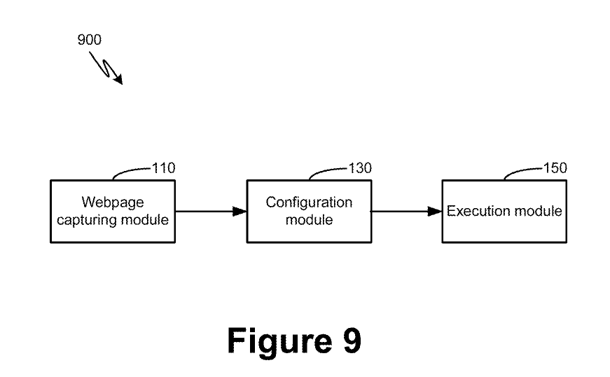

FIG. 9 is a simplified diagram showing a device for webpage sound control according to one embodiment of the present invention. The diagram is merely an example, which should not unduly limit the scope of the claims. One of ordinary skill in the art would recognize many variations, alternatives, and modifications. The device 900 includes a capturing module 110, a configuration module 130 and an execution module 150.

According to one embodiment, the webpage capturing module 110 is configured to capture one or more audio webpages from webpages opened in a browser, the audio webpages being loaded with media information. For example, if the webpages opened in the browser contain one or more audio webpages, the webpage capturing module 110 captures the one or more audio webpages among the webpages opened in the browser in order to obtain the audio webpages. As an example, audio webpages are webpages loaded with audio or video media information, such as webpages that play video or other streaming audio media, webpages containing streaming media advertising, etc.

According to another embodiment, multiple webpages opened in a browser may include audio webpages, and other webpages loaded with text information and/or image information. For example, the webpages that are opened in the browser appear as tabs in a browser interface, or in the format of a webpage window. In another example, on a personal computer, multiple webpages are opened as tabs in a browser that supports tabs. In yet another example, on a handheld device platform, multiple webpages are opened as webpage windows.

According to yet another embodiment, the configuration module 130 is to configure an operation widget based on at least information associated with the audio webpages, the operation widget being configured to gather operations associated with the audio webpages. After the audio webpages from the opened webpages are captured and obtained, the configuration module 130 configures the operation widget based on the audio webpages so that the operations associated with the audio webpages are gathered through the operation widget, in some embodiments. For example, the configuration module 130 configures a corresponding operation interface in the operation widget based on the audio webpages. As an example, the operation interface includes a button for controlling playing of the audio webpages, a preview interface corresponding to the audio webpages, and a close button corresponding to the audio webpages.

In one embodiment, while the audio webpages are captured, the operation widget, after being configured, floats in the browser interface, and disappears in the browser interface once all the audio webpages among all webpages are closed, so that the disturbance caused to the browser interface can be avoided. For example, a minimize button and an expanding button are configured in the operation widget. As an example, the operation widget can be minimized once a user clicks on the minimize button, so that the operation widget disappears in the browser. In another example, the expanding button is configured in the browser interface. In yet another example, the operation widget can be minimized if the user does not need control over the audio webpages. In yet another example, if the operation widget is needed, the operation widget can be obtained in response to the user's clicking on the expanding button.

In another embodiment, the execution module 150 is configured to receive one or more operations triggered for the operation widget and execute one or more operation instructions associated with the audio webpages based on at least information associated with the received operations. For example, the operation instructions are configured to control at least one audio webpage, and include playing, previewing, and closing the audio webpages. As an example, the execution module 150 detects the operations triggered from the operation widget, and the control of playing, previewing and closing the audio webpages is achieved based on the detected operations. The audio webpages opened in the browser are gathered and clarified through the operation widget, so that a user may locate the audio webpages and control the audio webpages quickly and easily through the operation widget which is integrated and easily operated, according to certain embodiments.

In yet another embodiment, the operation widget is configured to execute a same operation for all audio webpages. For example, the same operation can be executed through all the audio webpages opened in the browser through the operation widget. As an example, the operation of stopping or pausing playing can be executed to all the audio webpages so that all the audio webpages are controlled quickly and easily, so as to avoid the disturbance caused to the user.

According to one embodiment, the execution module 150 is configured to detect a first operation that triggers the operation widget to stop or pause media playing on the one or more audio webpages and stop or pause media playing on the one or more audio webpage based on at least information associated with the first operation. For example, upon detecting the operation that triggers stopping or pausing the media playing of at least one audio webpage, the execution module 150 stops or pauses media playing of the audio webpages. In another example, if the operation widget that is configured and obtained based on the audio webpages configures a button to control playing of at least one audio webpage, e.g., a button for stopping and/or pausing content, the execution module 150 stops or pauses media playing after the operation triggered from the button is detected. In yet another example, when the operation for the button is triggered again, media playing of the audio webpages resumes or continues.

In some embodiments, the execution module 150 controls media playing of one or more audio webpages through the operation widget so as to avoid inconvenience caused to a user when the user cannot locate which webpage performs media playing to make sounds. For example, the user opens multiple webpages using a browser, but the user has not finished browsing the opened webpages when the browser is closed. As an example, the opened webpages are not closed and thus the unclosed webpages are recovered automatically when the browser is opened again. The recovered audio webpages may make sounds and cause inconvenience to the user. The operation widget and the operation triggered from the operation widget can improve webpage sounds control, according to certain embodiments.

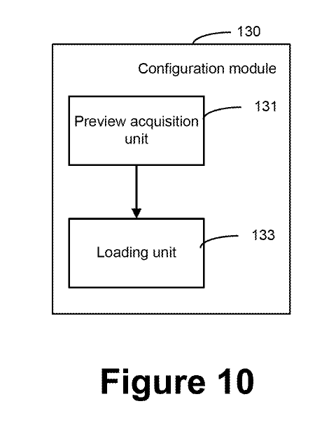

FIG. 10 is a simplified diagram showing a configuration module as part of the device as shown in FIG. 9 according to one embodiment of the present invention. The diagram is merely an example, which should not unduly limit the scope of the claims. One of ordinary skill in the art would recognize many variations, alternatives, and modifications. The configuration module 130 includes a preview obtaining unit 131 and a loading unit 133.

According to one embodiment, the preview obtaining unit 131 is configured to obtain a preview image corresponding to the audio webpages. For example, the preview obtaining unit 131 obtains the preview corresponding to each audio webpage that is captured. In another example, the loading unit 133 is configured to load the preview image to a preview interface of the operation widget. In yet another example, the loading unit 133 loads the preview interface of the operation widget with the obtained preview one at a time, so that the user is able to preview the audio webpages through the operation widget.

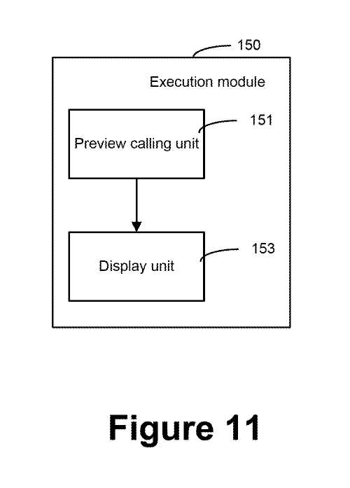

FIG. 11 is a simplified diagram showing an execution module as part of the device as shown in FIG. 9 according to one embodiment of the present invention. The diagram is merely an example, which should not unduly limit the scope of the claims. One of ordinary skill in the art would recognize many variations, alternatives, and modifications. The execution module 150 includes a preview calling unit 151 and a displaying unit 153.

According to one embodiment, the preview calling unit 151 is configured to detect a second operation that triggers the operation widget to carry out a webpage preview and call the preview interface from the operation widget based on at least information associated with the second operation. For example, the preview calling unit 151 calls one or more preview pages from the operation widget through an operation for previewing audio webpages triggered in the operation widget. As an example, the preview pages are loaded with preview images corresponding to the audio webpages. In another example, a preview button is configured in the operation widget, and the preview calling unit 151 calls the preview interface corresponding to the audio webpages from the operation widget through the operation triggered for the preview button.

According to another embodiment, the displaying unit 153 is configured to display the called preview interface. For example, the displaying unit 153 displays the called preview interface through the operation that triggers the operation widget to preview the webpages, so that the user is able to preview every opened audio webpage using the preview interface. In another example, preview of all the captured audio webpages among the opened webpages can be achieved in the preview interface. Which opened webpages are audio webpages are determined through the preview interface according to certain embodiments. For example, the displaying unit 153 displays the called preview interface above the operation widget, so that the preview corresponding to the audio webpages loaded one at a time is displayed in parallel in the preview interface.

According to yet another embodiment, the execution module 150 includes a webpage redirection unit. For example, the webpage redirection unit is configured to obtain a selection operation triggered in the preview interface and redirect from a currently displayed webpage to the one or more audio webpage corresponding to the preview interface based on at least information associated with the selection operation. For example, the audio webpages are previewed through the preview images loaded in the preview interface. In another example, the webpage redirection unit obtains a selection operation triggered for a preview image in the preview interface, and acquires the selected preview image based on the selection operation. The webpage redirection unit performs a redirection from a current webpage in the browser to an audio webpage corresponding to the preview image so as to realize the switching between the current webpage and the audio webpage without requiring the user to search for the audio webpage, which results in improvement of the operation efficiency, according to certain embodiments.

According to one embodiment, a method is provided for webpage sound control. For example, one or more audio webpages are obtained from webpages opened in a browser, the audio webpages being loaded with media information; an operation widget is configured based on at least information associated with the audio webpages, the operation widget being configured to gather operations associated with the audio webpages; one or more operations triggered for the operation widget are received; and one or more operation instructions associated with the audio webpages are executed based on at least information associated with the received operations. The operation instructions are configured to control the audio webpages. For example, the method is implemented according to at least FIG. 1.

According to another embodiment, a device for webpage sound control includes: a webpage capturing module configured to capture one or more audio webpages from webpages opened in a browser, the audio webpages being loaded with media information, a configuration module configured to configure an operation widget based on at least information associated with the audio webpages, the operation widget being configured to gather operations associated with the audio webpages, and an execution module configured to receive one or more operations triggered for the operation widget and execute one or more operation instructions associated with the audio webpages based on at least information associated with the received operations. The operation instructions are configured to control the audio webpages. For example, the device is implemented according to at least FIG. 9.

According to yet another embodiment, a non-transitory computer readable storage medium includes programming instructions for webpage sound control. The programming instructions are configured to cause one or more data processors to execute certain operations. For example, one or more audio webpages are obtained from webpages opened in a browser, the audio webpages being loaded with media information; an operation widget is configured based on at least information associated with the audio webpages, the operation widget being configured to gather operations associated with the audio webpages; one or more operations triggered for the operation widget are received; and one or more operation instructions associated with the audio webpages are executed based on at least information associated with the received operations. The operation instructions are configured to control the audio webpages. For example, the storage medium is implemented according to at least FIG. 1.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for webpage sound control, the method comprising:
capturing one or more audio webpages from webpages opened in a browser, the audio webpages being loaded with media information;
configuring an operation widget based on at least information associated with the audio webpages, the operation widget being configured to gather operations associated with the audio webpages;
receiving one or more operations triggered for the operation widget; and
executing one or more operation instructions associated with the audio webpages based on at least information associated with the received operations;
wherein the operation instructions are configured to control the audio webpages.

2. The method of claim 1, wherein the operation widget is configured to cant' out a same operation for the one or more audio webpages.

3. The method of claim 1, wherein the receiving an operation triggered for the operation widget and the executing one or more operation instructions associated with the audio webpages based on at least information associated with the received operation include:
detecting a first operation that triggers the operation widget to stop or pause media playing on the one or more audio webpages; and
stopping or pausing media playing on the one or more audio webpage based on at least information associated with the first operation.

4. The method of claim 1, wherein the configuring an operation widget based on at least information associated with the audio webpages includes:
obtaining a preview image corresponding to the audio webpages; and
loading the preview image to a preview interface of the operation widget.

5. The method of claim 4, wherein the receiving one or more operations triggered for the operation widget and the executing one or more operation instructions associated with the audio webpages based on at least information associated with the received operations include:
detecting a second operation that triggers the operation widget to carry out a webpage preview;
calling the preview interface from the operation widget based on at least information associated with the second operation; and
displaying the preview interface.

6. The method of claim 5, wherein the receiving one or more operations triggered for the operation widget and the executing one or more operation instructions associated with the audio webpages based on at least information associated with the received operations further include:
obtaining a selection operation triggered in the preview interface; and
redirecting from a currently displayed webpage to the one or more audio webpage corresponding to the preview interface based on at least information associated with the selection operation.

7. A device for webpage sound control, the device comprising:
a webpage capturing module configured to capture one or more audio webpages from webpages opened in a browser, the audio webpages being loaded with media information;
a configuration module configured to configure an operation widget based on at least information associated with the audio webpages, the operation widget being configured to gather operations associated with the audio webpages; and
an execution module configured to receive one or more operations triggered for the operation widget and execute one or more operation instructions associated with the audio webpages based on at least information associated with the received operations;
wherein the operation instructions are configured to control the audio webpages.

8. The device of claim 7, wherein the operation widget is configured to carry out a same operation for the one or more audio webpages.

9. The device of claim 7, wherein the execution module is also configured to detect a first operation that triggers the operation widget to stop or pause media playing on the one or more audio webpages and stop or pause media playing on the one or more audio webpage based on at least information associated with the first operation.

10. The device of claim 7, wherein the configuration module includes:
a preview obtaining unit configured to obtain a preview image corresponding to the audio webpages; and
a loading unit configured to load the preview image to a preview interface of the operation widget.

11. The device of claim 10, wherein the execution module includes:
a preview calling unit configured to detect a second operation that triggers the operation widget to carry out a webpage preview and call the preview interface from the operation widget based on at least information associated with the second operation; and
a displaying unit configured to display the preview interface.

12. The device of claim 11, wherein the execution module further includes:
a webpage redirection unit configured to obtain a selection operation triggered in the preview interface and redirect from a currently displayed webpage to the one or more audio webpage corresponding to the preview interface based on at least information associated with the selection operation.

13. The device of claim 7, further comprising:
one or more data processors; and
a computer-readable storage medium;
wherein one or more of the webpage capturing module, the configuration module, and the execution module are stored in the storage medium and configured to be executed by the one or more data processors.

14. A non-transitory computer readable storage medium comprising programming instructions for webpage sound control, the programming instructions configured to cause one or more data processors to execute operations comprising:
capturing one or more audio webpages from webpages opened in a browser, the audio webpages being loaded with media information;
configuring an operation widget based on at least information associated with the audio webpages, the operation widget being configured to gather operations associated with the audio webpages;
receiving one or more operations triggered for the operation widget;
executing one or more operation instructions associated with the audio webpages based on at least information associated with the received operations;
wherein the operation instructions are configured to control the audio webpages.
